(19) United States
(12) Patent Application Publication
(10) Pub. No.: US 2017/0365021 A1
(43) Pub. Date: Dec. 21, 2017

(54) Idea and Trade Secret Management Systems and Methods

(71) Applicant: CPA GLOBAL LIMITED, Saint Helier (GB)

(72) Inventors: Tyron Jerrod Stading, Austin, TX (US); Adam M. Bodnar, Austin, TX (US); Clifford Scott Herrick, Austin, TX (US); Maneesha D. Joshi, Austin, TX (US); Sergio E. Furgeson-Moreira, Austin, TX (US)

(21) Appl. No.: 15/607,259

(22) Filed: May 26, 2017

Related U.S. Application Data
(60) Provisional application No. 62/342,863, filed on May 27, 2016.

(51) Int. Cl. G06Q 50/18; G06Q 10/06; G06Q 10/10; G06F 17/27; G06F 3/0482

(52) U.S. Cl. CPC G06Q 50/184; G06Q 10/06311; G06Q 10/10; G06F 3/0482; G06F 17/2785; G06Q 10/1053

(57) ABSTRACT

Embodiments of devices, systems, methods and apparatuses are described that can be configured to provide at least one of an inventor portal, a resume builder, and an intellectual property asset management system. In one embodiment, the system may be configured to allow a first user to draft, revise, and submit an invention disclosure and to provide a resume builder configured to automatically generate a resume. The system may be further configured to provide an intellectual property asset management system configured to allow an administrator to review, edit, and provide comments to the invention disclosure. Additionally, the intellectual property asset management system may be further configured to allow the administrator to assign the invention disclosure to an entity and to monitor progress with respect to a plurality of tasks.

### CROSS-REFERENCE TO RELATED APPLICATION(S)

This application is a non-provisional of and claims priority to U.S. Provisional Patent Application No. 62/342,863 filed on May 27, 2016 and entitled “Idea and Trade Secret Management Systems and Methods,” which is incorporated herein by reference in its entirety.

### FIELD

The present disclosure is generally related to disclosure management systems and methods.

### BACKGROUND

Invention disclosures may take a variety of different forms and structures, and can include varying amounts of information. Often, such documents provide little detail to assist decision-makers in deciding whether to expend resources to pursue Intellectual Property protection for the disclosure.

### SUMMARY

Embodiments of disclosure management systems and methods are described below that can be configured to receive information related to an invention, to automatically evaluate the information to assist a submitter in providing a substantially complete disclosure, and to assist a reviewer in evaluating submitted ideas, trade secrets, and other proprietary information.

In some embodiments, the disclosure management systems and methods may be configured to receive data corresponding to one of an idea and a trade secret from an interface. In response to receiving the data, the system may semantically process the data, search one or more data sources based on the semantic processing, and receive results related to the data in response to the search. The system may further process the results to determine an extent of correlation between the received data and the results to determine a novelty parameter. The system may update the interface with data related to the search results. In some embodiments, the system may display the data related to the search results to encourage the operator to supply further details. In some aspects, the system may provide one or more prompts to a submitter, based at least in part on the results and the determined correlation between the submitted information and the results, to encourage the submitter to refine his or her submission to differentiate the submitted information from the results.

In some embodiments, an apparatus may include an interface configured to communicate with a computing device through a network, a processor coupled to the interface, and a memory accessible to the processor. The memory may be configured to store instructions that, when executed, cause the processor to receive data including at least one of an idea, a trade secret, and other proprietary information from a computing device associated with a user. The memory may further include instructions that, when executed, may cause the processor to semantically process the received data, and to automatically search one or more data sources based on the received data to identify related documents, potential collaborators, and so on. Further, the memory may store instructions that can cause the processor to provide a graphical interface including at least a portion of the received data and data corresponding to the related documents to a computing device through the network. In some aspects, the memory may further include instructions that, when executed, cause the processor to prompt the user to clarify the data related to the idea or trade secret.

In still other embodiments, a system may include an interface configured to communicate with a computing device through a network, a processor coupled to the interface, and a memory accessible to the processor. The memory can be configured to store instructions that, when executed, cause the processor to provide an inventor portal configured to allow a first user to draft, revise, and submit an ideas, trade secrets, other proprietary information, or any combination thereof. Further, the memory may include instructions that, when executed, may cause the processor to provide an intellectual property asset management system configured to allow an administrator to review, edit, and provide comments to submitted information. Further, the instructions may cause the processor to provide the intellectual property asset management system further configured to allow the administrator to assign submitted data and one or more tasks to an entity (such as a particular user, a department, and so on) and to monitor progress with respect to of the one or more tasks.

In certain embodiments, the memory may include instructions that, when executed, can cause the processor to determine potential collaborators for suggesting individuals who may assist with development of a particular invention disclosure, for example. In an example, the memory may include instructions that, when executed, cause the processor to provide a resume builder configured to automatically generate a resume for each user or subscriber. In an example, at least a portion of the information in the generated resume may be determined from account information provided by the user. The resume may be further supplemented by searching one or more data sources to identify documents and projects associated with the user. Further, the memory may include instructions that, when executed, cause the processor to provide an interface including the collected resume data and including one or more user-selectable elements accessible by a user to edit the resume data.

### BRIEF DESCRIPTION OF THE DRAWINGS

FIG. 1 illustrates a block diagram of a system configured to automatically manage disclosures, in accordance with certain embodiments of the present disclosure.

FIG. 2 depicts a block diagram of an inventor portal system, in accordance with certain embodiments of the present disclosure.

FIG. 3 depicts a block diagram of an Intellectual Property (IP) asset management system, in accordance with certain embodiments of the present disclosure.

FIG. 4 depicts a block diagram of an automatic curriculum vitae builder, in accordance with certain embodiments of the present disclosure.

FIG. 5 depicts a flow diagram of a method of automatically generating a resume, in accordance with certain embodiments of the present disclosure.

FIG. 6 depicts a graphical user interface (GUI) of a resume builder portion of an inventor portal, in accordance with certain embodiments of the present disclosure.

FIG. 7 depicts a GUI of a resume builder portion of an inventor portal, in accordance with certain embodiments of the present disclosure.

FIG. 8 depicts a flow diagram of a method of automatically generating a resume, in accordance with certain embodiments of the present disclosure.

FIG. 9 depicts a GUI that can be presented by the inventor portal to create, review, edit, and submit an invention disclosure document.

FIG. 10 depicts a flow diagram of a method of capturing an invention disclosure, in accordance with certain embodiments of the present disclosure.

FIG. 11 depicts a flow diagram of a method of identifying potential collaborators or experts to assist with the invention disclosure, in accordance with certain embodiments of the present disclosure.

FIG. 12 depicts a GUI of an administrative portal, in accordance with certain embodiments of the present disclosure.

FIG. 13 depicts a flow diagram of a method of providing an automatic recommendation for a submitted disclosure, in accordance with certain embodiments of the present disclosure.

FIG. 14 depicts a flow diagram of a method of selectively updating an administrative portal, in accordance with certain embodiments of the present disclosure.

FIG. 15 depicts a flow diagram of a method of managing an IP asset, in accordance with certain embodiments of the present disclosure.

FIG. 16 illustrates a flow diagram of a method of processing a submitted idea, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

In the following detailed description of embodiments, reference is made to the accompanying drawings which form a part hereof, and which are shown by way of illustrations. It is to be understood that features of various described embodiments may be combined, other embodiments may be utilized, and structural changes may be made without departing from the scope of the present disclosure. It is also to be understood that features of the various embodiments and examples herein can be combined, exchanged, or removed without departing from the scope of the present disclosure.

In accordance with various embodiments, the methods and functions described herein may be implemented as one or more software programs running on a computer processor or controller. In accordance with various embodiments, the methods and functions described herein may be implemented as one or more software programs running on a computing device, such as a tablet computer, smartphone, personal computer, server, or any other computing device. Dedicated hardware implementations including, but not limited to, application specific integrated circuits, programmable logic arrays, and other hardware devices can likewise be constructed to implement the methods and functions described herein. Further, the methods described herein may be implemented as a device, such as a computer readable storage medium or memory device, including instructions that when executed cause a processor to perform the methods described herein.

Embodiments of systems, methods, computing devices, and computer-readable instructions stored on a non-volatile memory are described below that may at least partially automate the generation of a resume. In certain embodiments, a computing device may receive data identifying a particular user and may retrieve data corresponding to the particular user from one or more data sources. The data sources may include social media websites, networking sites, local data, other data, or any combination thereof, and the computing device may extract, transform and load such data, process the data, and populate portions of a selected resume template with the extracted and processed data.

Embodiments of a disclosure management system and methods are described below that may include a computing device configured to receive disclosures, automatically identify related art, and automatically communicate with an operator based on the identified art to develop the disclosure. In some embodiments, the computing device may be configured to search a private database of disclosures to identify duplicate disclosures. Further, the computing device may be configured to identify one or more potential collaborators or experts based on the disclosure and based on an automatically determined expertise of the one or more collaborators and to communicate information about the one or more potential collaborators to the operator.

In some examples, the computing system may identify one or more experts for the submitter to collaborate with, identify overlaps within internal projects that could be consolidated to avoid duplication of work product. Additionally, the computing device may be configured to communicate the disclosure and collaborator data to an administrator for further review. In some embodiments, the computing device may communicate an interface to another computing device associated with the administrator to facilitate assignment and workflow monitoring by the administrator. The computing system may be configured to identify export control issues in order to prevent problems. Further, the system may track progress of a project and may who made particular changes to a document, which information may be used to identify “true ownership” when it comes to determining inventorship, for example.

Embodiments described below may be used to automatically populate a resume template from data gathered from a user, from social media, from web sites, and from other data sources to produce a resume that can be edited by a user and published to a selected form for download. By automatically extracting user experiences, talents, and accomplishments from web sites and from other data sources, a resume can be automatically created. In a particular example, a resume could be automatically created using patent data, assigning particular projects and technical documents to a particular inventor based on his or her involvement as an inventor or co-inventor on a particular patent document. The automatically created resume can be edited by selecting elements within a GUI, which may be rendered within an Internet browser application. Once the user is finished editing the resume information within the GUI, the user may select an option to publish or download the resume in a selected format.

In some embodiments, the system may be configured to gamify the invention disclosure process by creating competition between inventors to incentivize invention disclosure submissions. In a particular example, the system may publish an inventor leaderboard, which may highlight a list of inventors who have had the largest number of patent filings, the largest number of patent issuances, the largest number of disclosure submissions, the largest number of disclosure submissions that are approved and accepted by a patent review committee, and so on. In some embodiments, an administrator may configure the parameters for automatic determination of the leaderboard. Further, the system can operate to facilitate disclosure capture and to enhance the submission process. Further, the system can be used by administrators to evaluate disclosures, to work iteratively with inventors and with other individuals within an IP management team, and to manage the workflow process from concept to filing (and optionally beyond). Other embodiments are also possible.

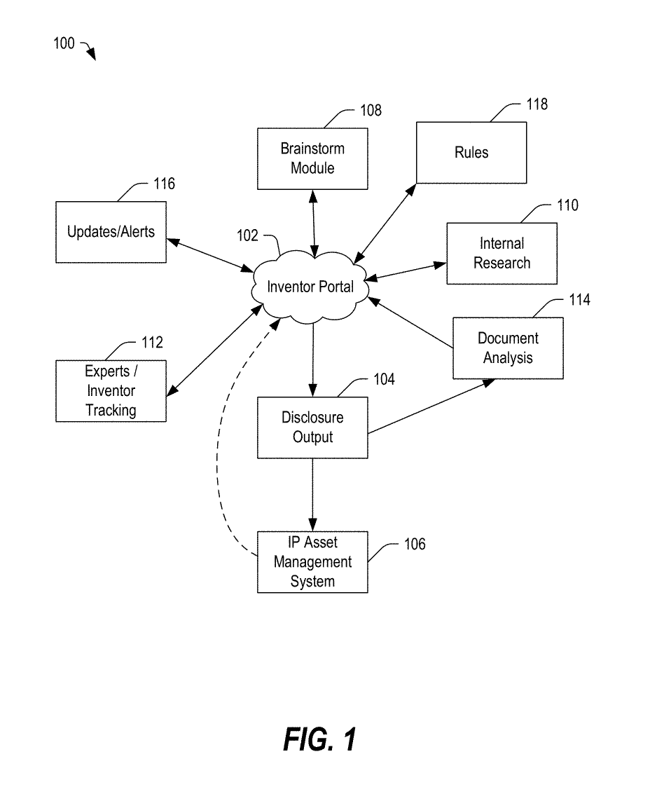

FIG. 1 illustrates a block diagram of a system 100 configured to automatically manage disclosures, in accordance with certain embodiments of the present disclosure. The system 100 may include an inventor portal 102 accessible by a user to enter information, which may eventually develop into a disclosure document. In some embodiments, the inventor portal 102 may interact with one or more other modules to develop information around the invention disclosure and to assist the user in producing a complete invention disclosure. Further, the inventor portal 102 may communicate a completed invention disclosure document to an IP management system 106.

In some embodiments, the inventor portal 102 may be configured to provide a graphical user interface (GUI) including information, user-selectable elements, including text inputs, buttons, pull-down menus, tabs, checkboxes, other inputs, or any combination thereof. The user may interact with the GUI to provide text, drawings and other information to create the invention disclosure document. Further, in some embodiments, the inventor portal 102 may present an inventor leaderboard within the GUI, which may be provided to a computing device of the inventor or user to incentivize the user to contribute invention ideas. In an example, the interface may be provided as a webpage that can be rendered within an Internet browser application executing on the computing device. Further, the inventor portal 102 may provide prompts, tutorials, guides, questions, and other information to a user to provide contextual clues for the research to help guide him or her through a process to create an action-oriented ideation.

The inventor portal 102 may communicate with the IP asset management system 106 through a disclosure output module 104. The inventor portal 102 may interact with a brainstorm module 108, which may be configured to provide one or more prompts, which can be presented within the GUI provided by the inventor portal 102 to encourage the user to provide information related to his or her invention concept. In some embodiments, the prompts may include popup questions, text boxes, text labels, or other indicators that can cause the inventor to think and add more information. In a particular example, the prompts may be context based, such that a short explanation in a text box may cause the brainstorm module 108 to provide a popup asking one or more questions, such as “What are the components of the invention?”; “What products can this be used with?” and so on. In some embodiment, the administrator of the IP management system 106 can customize the prompts, customize the invention disclosure GUI, or any combination thereof. In some embodiments, the brainstorm module 108 may utilize semantic searching, keyword searching, or other search techniques to identify related prior art in response to user interacts with the GUI. Excerpts from the related results may be presented within the GUI together with a prompt asking the inventor to provide further details to differentiate the invention disclosure details from related references.

In some embodiments, the inventor portal 102 may also interact with internal research 110, which may include previously submitted disclosures, documents and information collected by others, and so on. The internal research 110 may include previously submitted invention disclosures, patent documents, research information, and other information, including public information as well as private data.

The inventor portal 102 may be configured to identify experts or other inventors using the experts/inventor tracking module 112 and based on semantic analysis of the submitted information as well as search result information to identify potential partners for collaboration. In some instances, the experts/inventor tracking module 112 may identify collaborator expertise based on prior filings, writings, or other information about the potential collaborator. Further, the experts/inventor tracking module 112 may track inventor contributions to a particular disclosure, tracking and logging revisions made by each inventor to identify and track particular contributions and to attribute those contributions to a particular inventor. Such tracking information produced by the experts/inventor tracking module 112 can be used to produce the leaderboard that can be presented within the GUI provided to each user.

The user may interact with the inventor portal 102 to produce the invention disclosure and may respond to prompts and information provided within the GUI by the brainstorm module 108. Once the user is satisfied with his or her disclosure document, the user may submit the disclosure document, and the inventor portal 102 may provide the disclosure to the disclosure output 104. In some examples, the user may interact with the inventor portal 102 by emailing a disclosure document or other document to the inventor portal 102. The email address of the sender may be used to associate the document (or revisions within the document) with the particular submitter. In some examples, the inventor portal 102 may provide a graphical user interface (GUI) through which the user may enter and submit information. In other examples, the inventor portal 102 may provide forms that can be filled out within an Internet browser or using another application, such as a portable document format (PDF) editor, a text editor, or a word processor. The user may visit a web page associated with the inventor portal 102 to download an appropriate form, and then may submit the completed form to the inventor portal 102 as an attachment to an email or as an attachment to a submitted form. Other embodiments are also possible.

In response to receiving the disclosure document, the disclosure output 104 may provide the disclosure document to the document analysis module 114 for semantic review. The document analysis module 114 may extract content (information) from the submission, process the submitted information, search one or more data sources (such as such as patent office data, the Internet, various databases, and the like) based on the submitted information, determine correlations between the retrieved data and the submitted information, and provide feedback to one of the inventor and an administrator with respect to the submitted information. In an example, the document analysis module 114 may extract identifying information from a set of related prior art and may provide data related to the prior art to the user to evaluate the prior art and to add further details to distinguish the disclosed information from the prior art. In some examples, the document analysis module 114 may identify similar or duplicate disclosures within private data, and may associate information related to the identified disclosure with the submitted information. In some instances, the document analysis module 114 may also communicate with contracted research entities, librarians, and other skilled researchers to identify related information. Further, the document analysis module 114 may search internal research (disclosures, white papers, patent documents, etc.), which information (if relevant) may be provided within the GUI via the inventor portal 102, so that the information can be reviewed by an inventor. In some embodiments, the document analysis module 114 may provide information to the inventor or the administrator indicating the similarity to another disclosure, which may provide an opportunity to identify others to collaborate with, may identify overlaps within internal projects, which overlaps may be consolidated to avoid duplicate work (or duplicate filings), and so on.

In a particular embodiments, the inventor portal 102 may provide an alert (using the updates/alerts module 116) to the submitter that an update has been made to his or her invention disclosure. In particular, the inventor portal 102 may send an email or text to the inventor requesting that the inventor review related information. The user may then return to the inventor portal 102 to interact with the GUI to update the information.

In some embodiments, the document analysis module 114 may interact with pre-defined rules 118, which may specify particular workflow processes, access restrictions, information sharing protocols, other rules, or any combination thereof. In an example, the rules 118 may specify how research information may be shared with the submitter (e.g., removing information identified as sensitive or confidential, removing data that may expose the company to liability (such as claims of a patent), and so on). In an embodiment, related prior art references may be retrieved, and particular information (such as patent claims, inventor names, and so on) may be excised from the information provided to the operator. In some embodiments, the rules 118 may include broad category type of rules that restrict access to information based on the type of information, particular rules that enable or restrict information sharing between particular groups, rules specific to a particular disclosure, and so on. In certain embodiments, the rules 118 may be defined by an administrator. Other embodiments are also possible.

Once the disclosure is approved by the inventor, the inventor may communicate the disclosure to the inventor portal 102, which may forward the disclosure to the disclosure/output module 104, which may utilize the document analysis module 114 to process the submitted disclosure. Further, the disclosure/output module 104 may forward the disclosure to an IP asset management system 106 for review by an administrator. If, in the administrator's view, the disclosure requires further development, the administrator may send the disclosure back to the inventor portal 102 with questions or instructions for further refinement. In some embodiments, the disclosure/output module 104 may route the information as an email. In a particular example, the IP asset management system 106 may employ a “zero-inbox” methodology that may promote quick assessment of submissions.

In certain embodiments, the inventor portal 102 and the IP asset management system 106 may provide interfaces through which an administrative user may interact with a submission document, to review the disclosure, to review identified prior art, to review other information, and to submit or return the disclosure. In some embodiments, the administrator may interact with the IP asset management system 106 to assign the disclosure to an entity (such as a department, a law firm, a particular in-house attorney, and so on) for completion. The IP asset management system 106 may track progress of the handling of the disclosure, providing dashboards through which the administrator may manage the workflow process.

In certain embodiments, both the inventor portal 102 and the IP asset management system 106 may utilize time-stamps to assist in record keeping. In some embodiments, the IP asset management system 106 may identify internal projects that are similar to the submitted document, which may assist an administrator in identifying potential overlap between projects. Further, the IP asset management system 106 may be configured to identify a flag potential export control issues. Additionally, the IP asset management system 106 may be integrated with or otherwise configured to communicate with a human resources system or other organizational data source to determine information about available resources for recommending collaboration based on locality, department, other bases, or any combination thereof. Other embodiments are also possible.

In certain embodiments, the system 100 may be configured to facilitate capture and management of invention disclosures and other information (such as trade secrets). In a particular example, the invention portal 102 may be configured to provide a GUI through which a user may create, modify, enhance, or otherwise produce a disclosure document, which can be submitted for automated and administrative review at an IP management system 106.

The IP asset management system 106 may be configured to provide a GUI through which an administrator can review submitted invention disclosures and can manage invention disclosures as well as existing IP assets. In an example, the IP asset management system 106 can be configured to allow an administrator to assign a disclosure document to department, an individual, a firm, etc. In some instances, the IP management system 106 can be configured to facilitate management of IP procurement and management processes and workflows. Other embodiments are also possible.

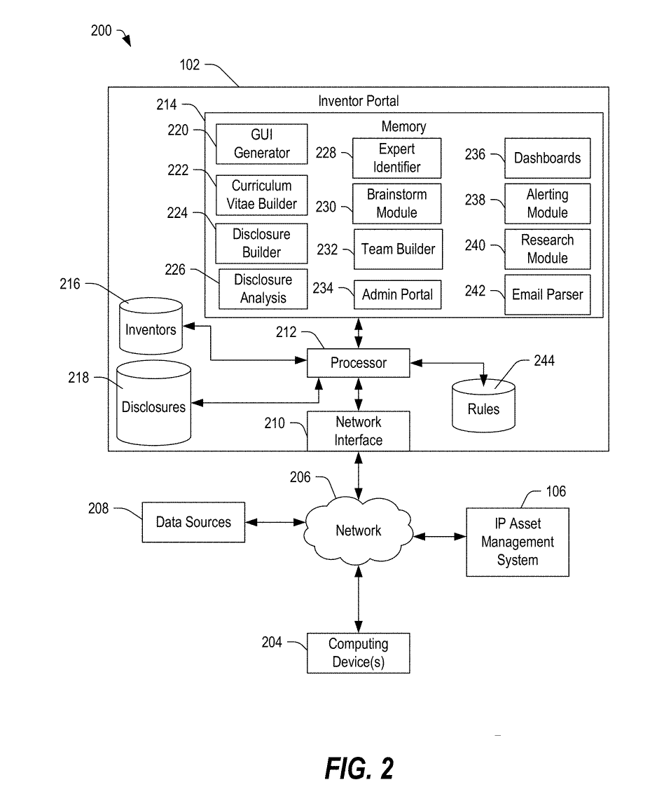

In certain embodiments, the inventor portal 102 may be implemented as a software application or server application configured to operate on a single computing system (such as a computer server) or on a plurality of computing devices (such as a cloud-computing system). One possible implementation of the inventor portal (depicted as a single computing device) is described below with respect to FIG. 2.

FIG. 2 depicts a block diagram of an inventor portal system 200, in accordance with certain embodiments of the present disclosure. The inventor portal system 200 may be a stand-alone inventor portal 102, or may be integrated as one or more software modules within an IP asset management system 106, depending on the implementation. In the illustrated example, the inventor portal system 200 may include an inventor portal 102 configured to communicate with the IP asset management system 106 through a network 206, such as the Internet, an enterprise network, another communications network, or any combination thereof. The inventor portal 102 may also communicate with one or more computing devices 204 and one or more data sources 208 via the network 206.

The inventor portal 102 may include a network interface 210 configured to communicate with the network 206. Further, the network interface 210 may be coupled to a processor 212, which may be coupled to a memory 214, an inventors database 216, and a disclosures database 218. In some embodiments, the inventors database 216 and the disclosures database 218 may be included within the memory 214. The inventors database 216 may include name and contact information associated with any user who subscribed to the inventor portal 102. The disclosures database 218 may include submitted invention disclosures, trade secrets, non-patent related information, ideas, partially developed concepts, other information, or any combination thereof.

The memory 214 may be configured to store data and instructions that, when executed, cause the processor 212 to provide a graphical user interface (GUI), to receive data from and to provide data to the computing device 204 to provide an iterative invention disclosure capture process. The memory 214 may include a GUI generator 220 configured to provide data, images, and one or more selectable elements (such as links, tabs, radio buttons, checkboxes, text fields, buttons, clickable images, or any combination thereof) through which an operator may interact with the system to select an automatically generated resume; to input, refine and submit an invention disclosure; and to iteratively adjust the disclosure.

The memory 214 further includes a curriculum vitae builder 222 that, when executed, may cause the processor 212 to automatically populate and generate a resume for a particular user. In some embodiments, based on login credentials, the system may identify multiple potential curriculum vitae items, and the GUI may present selectable elements for choosing between such potential items. Such identification may be based on user identifying information, which may be used to search whitepapers, disclosure documents, patents, patent applications, and other information. The information may be extracted from such documents and may be aggregated to form a preliminary resume. The user may interact with the GUI to accept or remove various identified items and to otherwise edit the resume.

Further, the memory 214 may include a disclosure builder 224 that, when executed, may cause the processor 212 to interact with the GUI generator 220 to provide an interface including text inputs, image upload elements, and other user-selectable elements accessible by a user to upload drawings, pictures and the like, to enter text, to enter data information, and to provide other information. In certain embodiments, the disclosure builder 224 may cause the processor 212 to process the uploaded data using a disclosure analysis module 226, which may be an an embodiment of the document analysis module 114 of FIG. 1.

In some embodiments, the disclosure analysis module 226 may cause the processor 212 to perform semantic analysis of the uploaded data and to query one or more data sources 208, disclosures 218, or any combination thereof to retrieve results related to the uploaded data. The disclosure analysis module 226 may also determine relevance between the uploaded data and the retrieved results and may provide data related to at least some of the retrieved results to the disclosure builder 224, which may remove identifying information (such as the document number, patent number, etc.). In some embodiments, the disclosure builder 224 may present a portion of the data within the interface. In an example, the data may be presented alongside the user-uploaded data, allowing the user to review the retrieved data adjacent to his or her text so that the user can add further details to differentiate the invention disclosure data from the retrieved data. As details are added, the disclosure builder 224 may provide the details to the disclosure analysis module 226, which may use the details to refine a search and retrieve more targeted references.

In one embodiment, the disclosure builder 224 may provide data regarding the retrieved documents including a count of the number of related patents found, as the user provides text inputs. In an example, as the details are added, fewer and fewer matching patent documents may be found, such that the number gradually trends toward zero (or at least a number in the single digits), thereby encouraging the operator to provide a relatively complete description. In some embodiments, the data may include the count and may include excerpts extracted from a pre-determined number (such as the top ten) of the most relevant retrieved documents. The combination of the document count plus the excerpts may motivate the user to provide a complete description to distinguish over the identified references.

The memory 214 may further include an expert identifier module 228 that, when executed, may cause the processor 212 to identify others who may be good candidates for collaboration based on their prior filings, education, experience, and so on. The identified experts may be provided within the interface with selectable elements to allow the user to choose experts with which to collaborate. The expert identifier module 228 can be an embodiment of the experts/inventor tracking module 112 of FIG. 1.

The memory 214 may also include a brainstorm module 230 that, when executed, may cause the processor 212 to present data related to relevant references and to prompt the user with questions related to those reference, related to the updated text, or both. The brainstorm module 230 can be an embodiment of the brainstorm module 108 of FIG. 1.

The memory 214 may also include a team builder module 232 that, when executed, may cause the processor 212 to coordinate communications between team members (collaborators). In an example, the user may select one or more identified experts or identify a co-inventor and the team builder module 232 may generate an alert to the co-inventor inviting him or her to work on the disclosure document in conjunction with the user. In some embodiments, the disclosure builder 224 may provide a whiteboard option allowing multiple users to collaborate on the input at the same time. Edits, changes and additions can be time-stamped and ascribed to a particular team member, thereby monitoring and tracking contributions. Other embodiments are also possible.

The memory 214 may further include an administrative portal 234 that, when executed, may allow an administrator to restrict teams, adjust various parameters, and so on. In some embodiments, the administrative portal 234 may be accessed by an administrator of an enterprise to add users, to adjust teams, and so on. In some embodiments, the administrative portal 234 may interact with a module of the IP asset management system 106 to perform various administrative functions. The memory 214 may also include a dashboards module 236 that can, when executed, cause the processor 212 to calculate and generate a leaderboard showing various inventor statistics, such as top 10 submitters, top 10 patent holders, and so on.

In some embodiments, the memory 214 may include an alerting module 238 that, when executed, may cause the processor 212 to auto-subscribe a particular user to alerts relating to his or her submission. The alerting module 238 may send alerts via text messages, emails, or whatever messaging preference the user specifies during signup.

The memory 214 may also include a research module 240 that, when executed, may cause the processor 212 to search private and public data sources to identify potentially relevant information. In some embodiments, in response to determining semantic similarity with a previously submitted document, the research module 240 may provide the identified information to the alerting module 238 for generation of an email or other alert to the user, to an administrator, or both. In some instances, the research module 240 may also cause the processor 212 to provide contextual clues to assist a research by guiding him or her through a process to create an action-oriented ideation. The research module 240 may further cause the processor 212 to coordinate parallel submission of ideas to outside researchers (e.g., independent contractors under a non-disclosure and non-compete contractual obligation).

The memory 214 may further include an email parser 242 that, when executed, may cause the processor 212 to extract content (attachments, text, etc.) from an email and to process the extracted content. In some examples, the email parser 242 may cause the processor 212 to extract, transform, and load the content into a temporary data table, and to further process the content, applying (for example) semantic tags and other labels to the content to assist with processes performed by other modules. For example, the email header information may be extracted (e.g., email address, time, date, etc.), and the data may be stored with the content. Further, if the email address is new to the inventor portal 102, human resources data may be accessed to populate an inventor record corresponding to the email address. The inventor record data may be stored in the inventor database 216, and the extracted content may be stored in the disclosure database 218 together with a link to associate the content with the particular inventor. Other embodiments are also possible.

The inventor portal 102 may further include rules 244, which may be configured by an administrator, by the inventor, by another operator, or any combination thereof. The rules 244 may define data sharing rules, which may identify the types of data that may be sensitive or subject to legal review (e.g., for willful infringement) and which may specify workflows or other processes for handling such data. The rules 244 may also define rules for sharing submitted data to outside researchers, for involving other collaborators (experts, etc.), for handling overlaps with other disclosures within private data, for sharing data between users and groups of users, or any combination thereof.

In some embodiments, the inventor portal system 200 may be configured to enable an inventor to enter information about a potential idea, such as a disclosure, a trade secret, a non-patent idea, and so on. The inventor portal system 200 may generally be configured to aid in a structured disclosure creation process. As the user is typing, when the user pauses, or after the user moves away from a text entry fields, the inventor portal system 200 may semantically process the text input, search one or more data sources, process the search results against the text input, and present data within the interface that corresponds to the most relevant search results.

In some embodiments, the presented data may include an indicator of the number of references found, text excerpts from at least some of the references, links to one or more of the references, and so on. In some embodiments, the presented data may include information about potential collaborators, similar ideas found in the enterprise's private data, contextual clues to guide the researcher to produce an action-oriented idea submission, other data, or any combination thereof. The user may interact with the data through the interface and may add details to the text input, causing the inventor portal system 200 to perform a refined search and to present new information. The process may proceed iteratively until the inventor is satisfied that his or her description is sufficiently detailed. In some embodiments, the inventor portal system 200 may refuse to allow the inventor to submit an invention disclosure if the number of relevant search results (having a semantic relevancy score of 90% or higher) is greater than a pre-determined number, such as ten. Thus, the inventor portal may force the inventor to include details in order to overcome the relevancy threshold, thereby ensuring a thorough disclosure submission. Such restrictions may be defined in the rules 244.

Further, upon submission, the inventor portal system 200 may auto-subscribe the user to receive alerts and notifications (using the alerting module 238) related to the submitted information. In some embodiments, submission of the document (via the inventor portal 102) may cause an email to be sent to the IP asset management system 106, which may trigger action on the submission via a “zero-inbox” type of methodology or block processing methodology. Other embodiments are also possible.

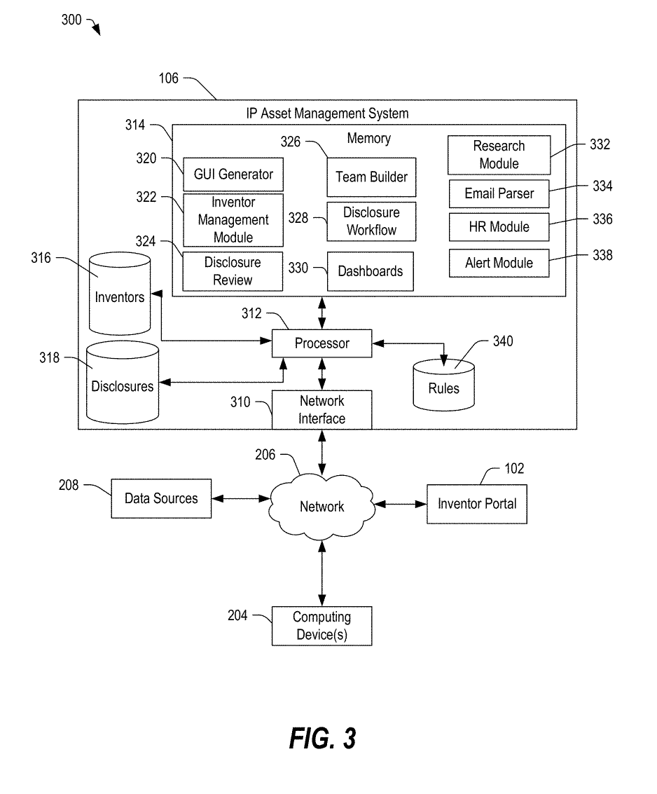

FIG. 3 depicts a block diagram of a system 300 including an Intellectual Property (IP) asset management system 106, in accordance with certain embodiments of the present disclosure. In some embodiments, the IP asset management system 106 may communicate with an inventor portal 102 through a network 206. In some embodiments, the inventor portal 102 may be part of the IP asset management system 106. The IP asset management system 106 may communicate with one or more computing devices 204 and one or more data sources 208 through the network 206.

The IP asset management system 106 may include a network interface 310 configured to communicate with the network 206. The network interface 310 may be coupled to a processor 312, which may be coupled to a memory 314, to an inventors database 316, and to a disclosures database 318. The inventors database 316 may include name and contact information associated with any user who subscribed to the inventor portal 102 as well as submission data, version information, collaboration data, and other information associated with the particular submitter. In some instances, the inventors database 316 may also include information received from human resources.

The disclosures database 318 may be an embodiment of the database 218 in FIG. 2. The disclosures database 318 may include submitted invention disclosures, trade secrets, non-patent related information, ideas, partially developed concepts, other information, or any combination thereof. In some instances, the information in the disclosures database 318 may be tagged such that identification of such data through a search may cause the system 106 to flag the search result and optionally generate an alert, trigger application of a rule, or any combination thereof.

The memory 314 may include a GUI generator 320 that, when executed, may cause the processor 312 to generate an interface that can be rendered within an Internet browser application on a computing device 204. The memory 314 may include an inventor management module 322 that, when executed, may cause the processor 312 to interact with the admin portal 234 of the inventor portal 102 in FIG. 2. In some embodiments, an administrator may interact with the interface provided by the GUI generator 320 to add inventors, to create collaboration rules and restrictions, to initiate collaboration, and so on. In some embodiments, the administrator may interact directly with an invention disclosure to add information, to insert a comment or question, to add a collaborator, and so on.

The memory 314 may include a disclosure review module 324 that, when executed, may cause the processor 312 to provide to the GUI generator 320 a selectable list of disclosures that have been submitted by inventors. The GUI generator 320 may provide the selectable list to the interface, and an administrator may select one or more of the invention disclosures for review. The memory 314 may also include a team builder module 326 that, when executed, may cause the processor 312 to identify potential collaborators and to present the potential collaborators within the interface so that the Administrator can select one or more of the collaborators to be included with the disclosure. In some embodiments, the administrator may interact with the interface to remove collaborators or to send a query to the inventor regarding selected collaborators.

In some embodiments, the memory 314 may include a disclosure workflow 328 that, when executed, may cause the processor 312 to identify tasks in a disclosure workflow, to allow the administrator to assign one or more of the tasks, and to monitor progress of the disclosure through the workflow. In some embodiments, the disclosure workflow 328 may, when executed, access one or more rules 340, which may determine how the submitted information may be processed, restricted, or shared and which may define workflows and other parameters associated with submitted information. The memory 314 may also include a dashboard module 330 that may be configured by an administrator to present statistics and to show the progress of various disclosures through the workflow processes. Other embodiments are also possible.

The memory 314 may further include a research module 332 that, when executed, may cause the processor 312 to analyze the submitted information against information included in disclosures database 318. In some embodiments, the research module 332 may identify similar or duplicate disclosures in the disclosures database 318. The memory 314 may also include an email parser application 334 that, when executed, may cause the processor 312 to extract, transform and load data from an email, including any attachments. The memory 314 may further include a human resources (HR) module 336 that, when executed, may cause the processor 312 to interact with HR data. In an example, the HR module 336 may identify potential collaborators or experts at the same facility or at a nearby facility with whom the submitter may collaborate. The memory 314 may also include an alerting module 338 that, when executed, may cause the processor 312 to generate email, text, other alerts, or any combination thereof in response to determining a duplicate submission, identifying a potential collaborator, receiving an email submission, and so on.

In some embodiments, in response to receiving an alert that a submission has been received, an administrator may access the IP asset management system 106 to review invention disclosure submissions and to selectively assign one or more tasks related to at least one of the submitted disclosures to a vendor or to an in-house employee to complete a task associated with the workflow. In some embodiments, the administrator may utilize the disclosure review module 324 to provide feedback to inventors, to ask questions, to edit the submitted disclosure, to add co-inventors/collaborators, or any combination thereof. Further, in some embodiments, one of the disclosure review module 324 and the dashboards module 330 may cause the processor 312 assign a score or recommendation to a particular disclosure to assist the administrator to determine whether to proceed with the particular disclosure. The score may include an indication of similarity to other (previously submitted) disclosures.

In certain embodiments, the IP asset management system 106 may be configured to process submitted information against private data, such as data within the disclosures database 318 to identify duplicate disclosures. In an example, such a search may be based on semantic analysis of the submitted document relative to pre-defined categories of information in which the previously submitted information may already be categorized. Thus, contextual searches may be used to focus the comparison. Further, term similarity, statistical analysis, semantic signatures, and other techniques may be used to compare document content within a related category. In an example, such identification may be used to prevent duplicate work. Further, in some instances, the IP asset management system 106 may provide an interface including the submitted information and data related to the duplicate disclosure to allow an administrator to review and make a determination whether to pursue. The data related to the submitted information and the disclosure may include a recommendation based on the amount of art found through research, a determined novelty, and various other parameters. In some instances, the similarity between the submitted information and the similar disclosure found in the disclosures database 318 may be used to make recommendations of experts who the submitter may want to collaborate with.

In some embodiments, the IP asset management system 106 may be configured to alert the administrator to potential export control issues for a particular product, concept, etc. Further, the IP asset management system 106 may allow the administrator to review version information and to review tracked modifications to determine who made a revision as it relates to submitted information. In the event that multiple inventors are associated with a particular invention disclosure submission, the IP asset management system 106 may track changes made by each contributor, including tracking the date, time, and particular content of the contribution. In some instances, such documentation may be used to facilitate an investigation related to inventorship.

In certain embodiments, the IP asset management system 106 may evaluate the semantic similarity between submitted information and a variety of other information, including identified prior art, related pre-existing disclosures, relevance to business direction, and so on. In some embodiments, such information may be weighted or scored by an administrator and may be adjusted as the business situation of the enterprise changes. In some embodiments, based on such evaluation, the IP asset management system 106 may be configured to make intelligent suggestions based on submitted information. Further, the IP asset management system 106 may auto-subscribe the submitter to alerts related to the submission. Further, the IP asset management system 106 may utilize rules 340 to identify submitted ideas that may be strategic to the company's goals. Such rules 340 may include semantic triggers configured to trigger alerts when ideas are submitted that are strategic to the company. In certain embodiments, the IP asset management system 106 can provide an administrative view into the evolution of ideas (through tracked changes and through parallel or block review of a plurality of related disclosures) to determine an organic evolution of a technology or IP strategy.

In certain embodiments, each submission (original, modification, edit, etc.) may be automatically time-stamped for record keeping. The rules 340 may define how ideas may be shared within divisions, among individual contributors, within groups, within teams, and between organizations, such as within a joint venture. The inventor portal 102 or the IP asset management system 106 may restrict information to prevent a particular user from seeing anything sensitive or that might be subject to legal review (e.g., patent claims from a competitor's patent).

In certain embodiments, the inventor portal 102, the IP asset management system 106, or both may use a “zero-inbox” methodology to promote the quick assessment of submitted ideas, such that the submissions inbox is maintained in a substantially empty state. In some embodiments, the inventor portal 102, the IP asset management system 106, or any combination thereof may provide contextual clues for the researcher to help guide him or her through a process to create action-oriented ideation. In some embodiments, the IP asset management system 106 may coordinate parallel submission of submitted ideas to outside researchers, which may help to advance the idea through further research. The IP asset management system 106 may be configured to capture ideas, trade secrets, and non-patent ideas to generally aid in a structured ideation process. In some embodiments, the IP asset management system 106 may monitor progress and changes to submitted concepts and may correlate a stage-gate process for commercialization related to the concepts. Email submissions may trigger analysis and recommendations, instead of or in addition to a web interface. By allowing communication between the IP asset management system 106 and HR systems, organizational data can be used to help recommend locality and department recommendations for collaboration and can track department, division, or other aspects for example for gamifying the submission process among individual contributors, groups, divisions, and so on. In some examples, the IP asset management system 106 may provide a leaderboard that uses trade secret, ideas, disclosures, and inventions to rank order inventors, groups, divisions, products, and so on within a company. Other embodiments are also possible.

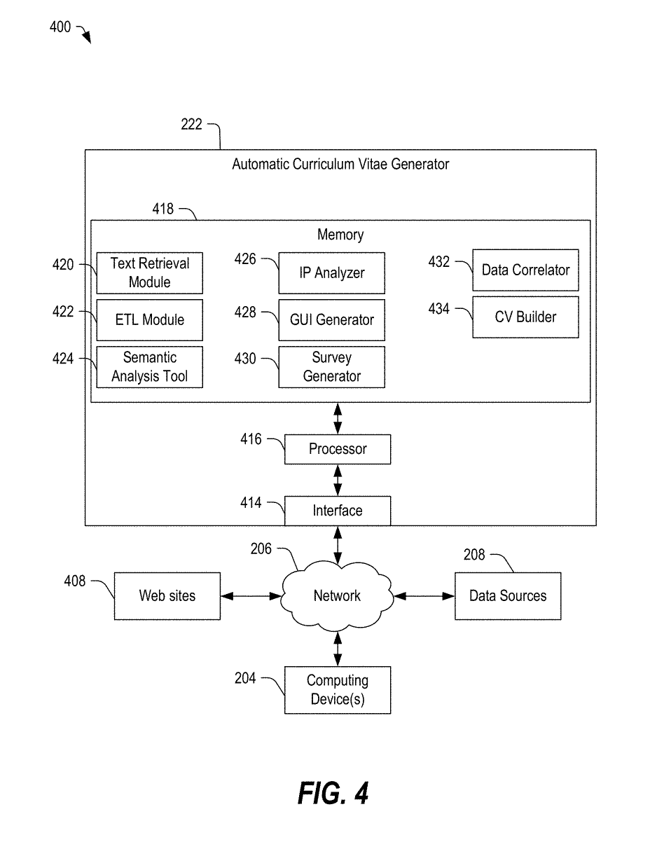

FIG. 4 illustrates a block diagram of a system 400 configured to automatically generate a resume, in accordance with certain embodiments of the present disclosure. The system 400 may include an automatic curriculum vitae generator 222 configured to communicate with one or more computing devices 104 through a network 106. The automatic curriculum vitae generator 222 may also be coupled to one or more data sources 208 directly or through the network 206. In certain embodiments, the automatic curriculum vitae generator 222 may be implemented on a computing device configured to communicate with data sources and with other computing devices.

In certain embodiments, in response to receiving data associated with a user from the computing device 204 via the network 206, the automatic curriculum vitae generator 222 may select a resume template from a plurality of resume templates, which may be stored locally or which may be retrieved from one of the data sources 208. Further, the automatic curriculum vitae generator 222 may retrieve data from one or more data sources 208 based on the received data. In an example, the automatic curriculum vitae generator 222 may generate one or more queries based on the data, which queries may be used to automatically search for data corresponding to the user on one or more websites, such as social networking sites, or within one or more databases (such as the United States Patent and Trademark Office databases) to retrieve data corresponding to the user. In an example, the automatic curriculum vitae generator 222 may assemble resume data by scraping information from patents that list the particular user as a co-inventor. In a particular example, one of the websites may include LinkedIn.com, which may include employment history data, education data, accomplishments, publications, presentations, and other information associated with the user. The automatic curriculum vitae generator 102 may extract data from the search results. In some embodiments, the search results may include data associated with the user and data that may have been identified using search terms derived from the data associated with the user. In some instances, the latter data may or may not be relevant to the particular user.

In certain embodiments, the automatic curriculum vitae generator 222 may extract data from the retrieved pages and may generate a graphical user interface (GUI) including a resume template at least partially populated with data associated with the user. Further, the GUI may include at least some of the retrieved data from the one or more data sources 208 and may include one or more user-selectable options accessible by a user to interact with the data. In some embodiments, the user may interact with one or more user-selectable options to select portions of the data for insertion in the resume template, to remove portions of the data from the resume template or from the selection options (e.g., to disassociate the retrieved data from the user), to arrange selected data within the resume template, to edit selected data within the resume template, or any combination thereof. In some embodiments, the user may interact with one or more user-selectable options to select between available resume templates, which may include different formatting, styles, and layouts.

In certain embodiments, once the user has selected a desired resume template and has selected the data for inclusion in the template, the user may interact with one or more user-selectable elements to finalize the resume. In certain embodiments, in response to selection of an element within the GUI, the GUI may communicate data to the automatic curriculum vitae generator 222 or may execute scripts embedded in the GUI to generate the resume in a selected format. The GUI may provide a link, a popup window, or another element accessible by a user to download the resume for local storage and optionally further editing.

The automatic curriculum vitae generator 222 may include an interface 414 configured to communicate with the network 206. The automatic curriculum vitae generator 222 may further include a processor 416 coupled to the interface 414 and coupled to a memory device 418. In certain embodiments, the memory device 418 may include a non-volatile memory, such as a hard disc drive, a flash memory, a compact disc (CD), another digital storage device, or any combination thereof.

In certain embodiments, the memory 418 may include a text retrieval module 420 that, when executed, may cause the processor 416 to receive data from a computing device 204 and to automatically generate one or more queries, which may be sent to one or more data sources to retrieve data. In certain embodiments, the processor 416 may send queries to a local data store and to other data sources, such as websites 408, including social media websites, the U.S. Patent and Trademark Office website, other data sources 208.

In certain embodiments, the memory 418 may include an extract, transform and load (ETL) module 422 that, when executed, may cause the processor 416 to extract data from search results, transform and organize the data into fields, and load the data into temporary tables. In certain embodiments, the memory 418 may include a semantic analysis tool 424 that, when executed, may cause the processor 416 to semantically analyze the data in the temporary tables to categorize the data and to select portions of the data, which selected portions may be provided as options for inclusion in a selected resume template. In certain embodiments, the semantic analysis tool 424 may utilize abstract or summary data, from portions of published articles or patents to produce a brief summary for inclusion in a resume.

In certain embodiments, the memory 418 may include an Intellectual Property (IP) Analyzer 426 that, when executed, may cause the processor 416 to retrieve patent documents, copyright documents, trademark documents and other information (i.e., Intellectual Property (IP) interests) from various governmental websites, which documents and information are associated with a particular user. In an example, the user's name may be used to search trademarks, patents, and copyrights to identify IP interests associated with the user, which IP interests can be provided as options for inclusion in a resume. In some embodiments, the name may be normalized to identify different instances including full names, nick names, middle initial (as opposed to full name), and so on, so that obvious variations can be correlated to the individual.

In certain embodiments, the memory 418 may include a GUI generator 428 that, when executed, may cause the processor 416 to generate a GUI including a selected resume template. In certain embodiments, the GUI generator 428 may cause the processor 416 to at least partially populate the selected resume template based on the data in the temporary tables, data determined by the semantic analysis tool 424, and data determined by the IP analyzer 426. The GUI may include such data as well as one or more user-selectable elements, such as buttons, links, tabs, check boxes, radio buttons, and other selectable elements. In certain embodiments, the user-selectable elements may be accessible by a user to select portions of the data, to edit data, to change the selected resume template, and to adjust the content, ordering, and arrangement of the data within the resume template. Other functions or features may also be selected by accessing the user-selectable elements.

In certain embodiments, the memory 418 may include a survey generator 430 that, when executed, may cause the processor 416 to prompt the user to answer one or more questions, and the data retrieved from the user's responses may be used to retrieve data from one or more data sources, to populate the GUI, or to enhance performance of the automatic curriculum vitae generator 222 in the future. The memory 418 may further include a data correlator 432 that, when executed, may cause the processor 416 to identify related data portions, such as different instances of the same employment experience retrieved from different data sources. In some embodiments, the data correlator 432 may also normalize name information, company information, and other data to capture variations, misspellings, abbreviations and the like, in order to correctly associate retrieved data to the individual user, and so on.

In certain embodiments, the memory 418 may include a curriculum vitae (CV) builder 434 that, when executed, may cause the processor 416 to assemble portions of the retrieved data into a selected template for finalization. Finalization of a resume template may include populating the resume template according to the selected data and organization and publishing the resume to a selected output format, such as a word processing document, a rich text format, or another format for editing. Other embodiments are also possible.

In certain embodiments, the GUI may include the selected resume template and may be rendered within an Internet browser application on a user's computer as a visualization of the data (i.e., as an image overlay arranged according to the resume format. When the user is satisfied with the content and arrangement of the data, the user may select one of the selectable elements within the GUI to finalize the resume. In response to selection of the option, the CV builder 434 may cause the processor 416 to populate the resume template with the selected data to produce a document, and may provide the document for download or send the document to the computing device.

In some embodiments, the automatic curriculum vitae generator 222 may automatically create resumes for a plurality of names. In an example, inventor names may be extracted from patent documents, and the generator 222 may automatically retrieve data corresponding to each inventor name and produce a resume for each inventor. The generated resume may include user-selectable options for modifying the content of the resume and the arrangement of the data within the resume. In certain embodiments, the GUI may include a user-selectable option to claim an existing resume. In certain embodiments, in response to selecting the option, the GUI may present the user with one or more options for establishing an account for control and subsequent management of the resume document and its contents.

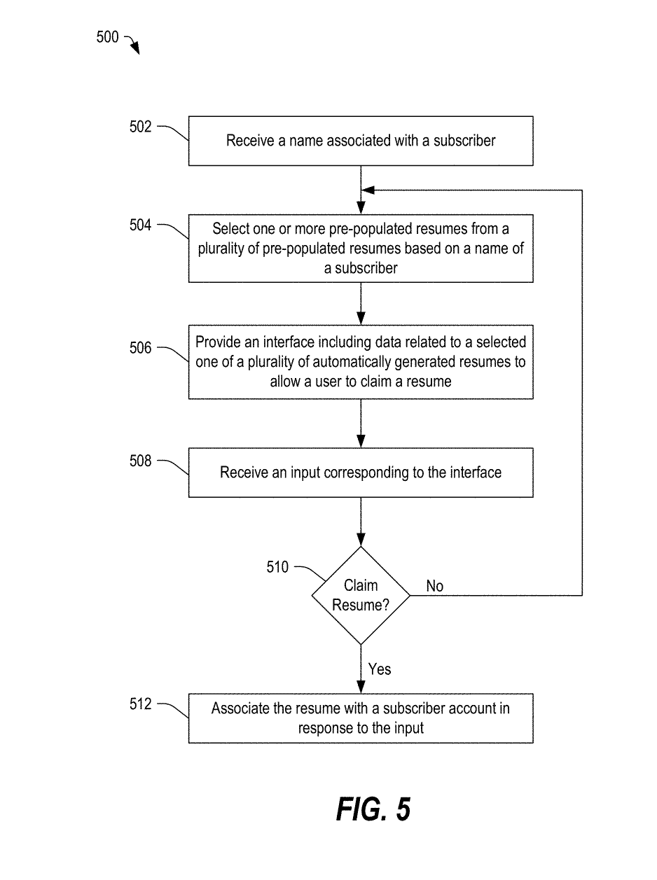

FIG. 5 depicts a flow diagram of a method 500 of automatically generating a resume, in accordance with certain embodiments of the present disclosure. At 502, the method 500 includes receiving a name associated with a subscriber. The name may be user's login credentials or may include a first name and a last name. Other embodiments are also possible.

At 504, the method 500 may include selecting a pre-populated resume from a plurality of pre-populated resumes based on the name of the subscriber. In some embodiments, the system may automatically generate one or more potential resumes in response to the user's name. In some embodiments, the system may retrieve pre-populated resumes based on the name.

At 506, the method 500 may include providing an interface including data related to a selected one of the plurality of automatically generated resumes to allow a user to claim a resume. In an example, the interface may include a selectable list of potential resumes, allowing a user to select and review one and optionally to edit the automatically prepared resume.

At 508, the method 500 may include receiving an input corresponding to the interface. In some embodiments, the input may include selection of one or more selectable elements. At 510, if the input indicates that the user is not claiming the selected resume, the method returns to 504 to select another of the pre-populated resumes. Otherwise, at 510, if the input indicates that the user is claiming the selected resume, the method 500 includes associating the resume with the subscriber account in response to the input, at 512. Other embodiments are also possible.

In an alternative embodiment, rather than selecting a pre-populated resume, the user may interact with the resume builder GUI to fill in some information and to select from one or more possible experiences found by the system to add to the resume template. The user may then interact with the template to rearrange the data, to edit the data, and to save the resume template. The saved resume may then be used by the system to identify opportunities for collaboration, based on experiences; education; previously submitted, filed or issued patent applications; engineering units; previous collaborations; and so on.

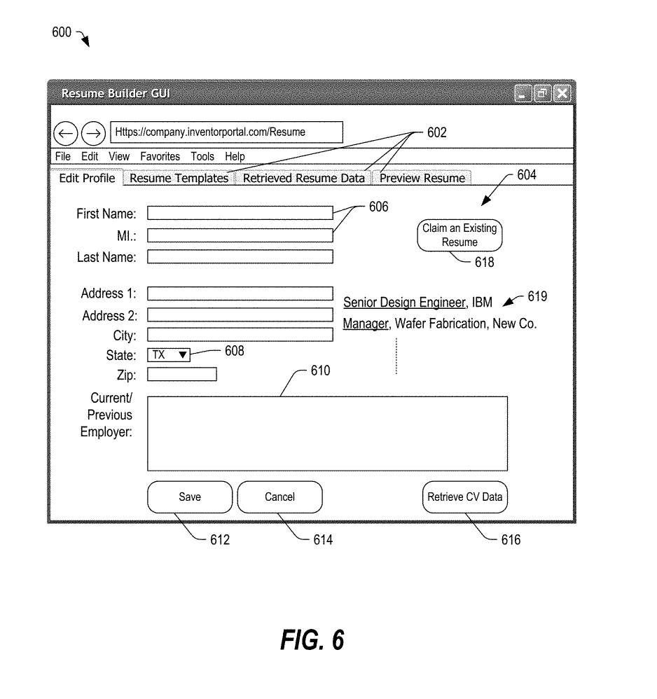

FIG. 6 depicts a graphical user interface (GUI) 600 that may be provided by a system configured to automatically generate a resume, in accordance with certain embodiments of the present disclosure. In certain embodiments, the GUI 600 may be generated and provided by the automated curriculum vitae generator 222 of FIG. 4. In certain embodiments, the GUI 600 may include a plurality of user selectable elements, such as tabs 602, text fields 606, pull-down menu 608, free-form text box 610, and buttons 612, 614, 616, and 618. In certain embodiments, the tabs 602 may include an “Edit Profile” tab, a “Resume Templates” tab, a “Configure Resume” tab, and a “Preview Resume” tab. In certain embodiments, the GUI 600 may include other selectable elements, such as clickable links, text fields, pull-down menus, checkboxes, radio buttons, other elements, or any combination thereof.

In certain embodiments, a user may select the “Edit Profile” tab to access the user selectable elements. The user may enter text into the text fields 606 and 610, and select a state. The user may then select the “Save” button 3612 to save the data. Alternatively, the user may select the “Cancel” button 614 to clear the data. In certain embodiments, the user may select the “Retrieve CV Data” button 616 to retrieve employment history, educational history, patent data, trademark data, publication data, and other information from various data sources, including governmental databases (e.g., the patent and trademark office website), social media websites, and so on. The user may then access the GUI 600 including the retrieved CV data to select, modify, rearrange and otherwise interact with the data to produce a desired resume document output. In an example, retrieved CV data may be presented as a clickable list 619, allowing the user to select and review items before adding them to the CV. Clicking on a list element may cause a popup window to be presented, from which the user may add or remove these items.

In certain embodiments, the user may select the “Claim an Existing Resume” button 618 to retrieve a list of one or more generated resumes that may correspond to the user. In certain embodiments, in response to selecting the “Claim an Existing Resume” button 618, the GUI 600 may provide a pop-up window including a list of identifiers, each of which may correspond to a particular automatically generated resume. A user may interact with the list to view and optionally claim one of the generated resumes. The user may then access the GUI including the retrieved resume to select, modify, rearrange and otherwise interact with the data to produce a desired resume document output.

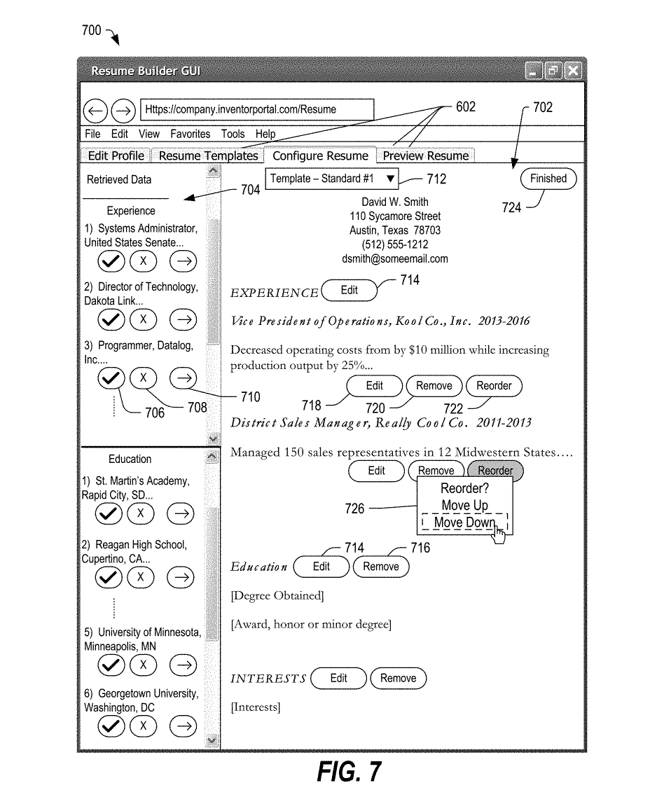

FIG. 7 illustrates a GUI 700 that may be provided by a system configured to automatically generate a resume, in accordance with certain embodiments of the present disclosure. The GUI 700 may include the tabs 602 as discussed above and may include a resume template panel 702 and a retrieved data panel 704. In certain embodiments, the retrieved data panel 704 may include data retrieved from various data sources, some of which may be duplicative. The retrieved data panel 704 may categorize the data into experience, education, and other categories. Further, in some embodiments, the retrieved data panel 704 may include a user-selectable elements, such as an “Accept” button 706 (indicated by a button including a check mark) accessible by a user to acknowledge that a particular data item corresponds to the user, a “Reject” button 708 (indicated by a button including an “X”) to disassociate the data from the user, and an “Add” button 710 (indicated by a button including an arrow) accessible by a user to add the data to the resume template. In certain embodiments, selection of the “Reject” button 708 may cause the GUI 700 to update, removing the selected data item from the retrieve data panel 404.

The resume template panel 702 may include a pulldown menu 712 that may be accessed by a user to alter the resume template, which may change the arrangement and formatting of the resume document and its content. The resume template panel 702 may further include an “Experience” category with an associated “Edit” button 714, which may be accessed by a user to edit the heading and its associated content. The resume template panel 702 may further include an “Education” category and an “Interests” category, with associated “Edit” buttons 714 and associated “Remove” buttons, which may be accessed by a user to remove the category, for example, if the user does not want to list such items or interest.

Further, each data item included within a particular category (such as those added by clicking the “Add” button 710 in the retrieved data panel 704, may be presented with at least a portion of the data as well as user selectable elements to adjust the data. For example, each data item may be presented along with an “Edit” button 718 that, when selected, may cause the GUI 700 to provide a popup window through which the user may edit at least one of the title, dates, location, or description for a particular item. Further, the GUI 700 may include a “Remove” button 720 accessible by a user to remove the particular data item and a “Reorder” button 722 accessible by a user to adjust the order of the data item within the particular category. The user may interact with such user selectable elements to adjust the content and its arrangement.

In the illustrated example, the user may have selected the “Reorder” button associated with the “District Sales Manager, Really Cool Co.” experience. Upon selection of the button, the GUI 700 presented a popup window 726, which provides the user the option of moving the data up in the “Experience” category by selecting the “Move Up” option or moving the data down in the “Experience” category by selecting the “Move Down” option. Upon selection, the associated data may be reordered within the GUI 700.

Once the user is satisfied with the content and arrangement (and with the selected resume template), the user may click a “Finished” button 724 to complete the document generation process. In certain embodiments, the selection of the “Finished” button 724 may cause the processor 416 of FIG. 4 to execute the CV builder 434 in order to generate the resume document.

It should be appreciated that the GUIs 600 and 700 depicted in FIGS. 6 and 7 are illustrative only. Further, it should be appreciated that selectable elements and the parts, content, and form of the GUIs may vary, depending on the specific implementation. For example, in certain embodiments, each data item may not have its own “Edit” and “Remove” buttons. Instead, each category may include user-selectable buttons that may be accessed to edit the content of the categories. Other embodiments are also possible.

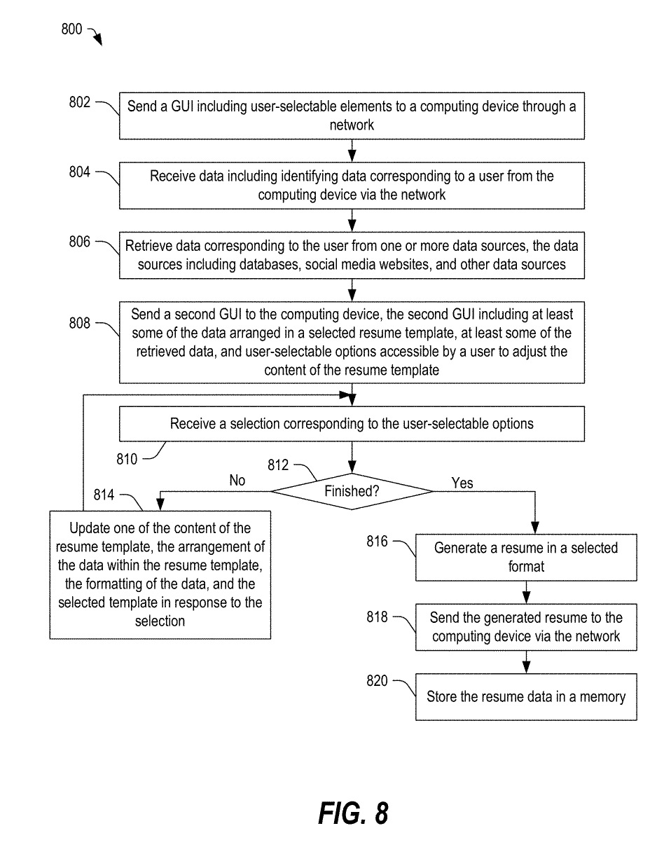

FIG. 8 depicts a flow diagram of a method 800 of generating a resume, in accordance with certain embodiments of the present disclosure. At 802, the method 800 may include sending a GUI including user-selectable elements to a computing device through a network. In some embodiments, the GUI may include input elements and selection elements that may be accessed by a user to set up a new account, to initiate automatic creation of a resume, to claim an existing automatically generated resume, or any combination thereof.

At 804, the method 800 may include receiving data including identifying data corresponding to a user from the computing device via the network. In some embodiments, the identifying data may include a user's name and other personally identifying information. In some embodiments, the identifying data may include an identifier associated with a selected one of a plurality of previously generated resumes.

At 806, the method 800 may include retrieving data corresponding to the user from one or more data sources, including databases, social media websites, and other data sources. The method 800 may include utilizing at least a portion of the identifying data to generate one or more queries, which may be sent to one or more data sources to retrieve data related to the identifying data associated with the user.

At 808, the method 800 may include sending a second GUI to the computing device, which second GUI may include at least some of the data arranged in a selected resume template, at least some of the retrieved data, and user-selectable options accessible by a user to adjust the content of the resume template. In some embodiments, the GUI may include a resume panel and a retrieved data panel. At 810, the method 800 may include receiving a selection corresponding to the user-selectable options.

At 812, if the selection indicates that the user is not finished, the method 800 may include updating one of the content of the resume template, the arrangement of the data within the resume template, the formatting of the data, and the selected template in response to the selection, at 814. The method 800 may then return to 810 to receive another selection.

Otherwise, at 812, if the selection indicates that the user is finished, the method 800 may include generating a resume in a selected format, at 816. The resume may be generated by populating the template with the selected information. At 818, the method 800 may include sending the generated resume to the computing device via the network (or making the document available for download in a selected format). At 820, the method 800 may further include storing the resume data in a memory. In certain embodiments, the user may revisit the website to edit or retrieve his or her resume at a later time.

In general, the elements described in FIG. 8 may be combined and some elements may be omitted without departing from the scope of the disclosure. In an example, the updating at 814 may occur based on each interaction with the GUI, and without concern for whether the user provides any indication of being finished. Further, in some embodiments, the resume may be automatically generated and stored with each change such that the user may select a download link to download the document at any time. Further, in some embodiments, data may be updated automatically within the GUI and without sending a second GUI with the retrieved data. Other embodiments are also possible.

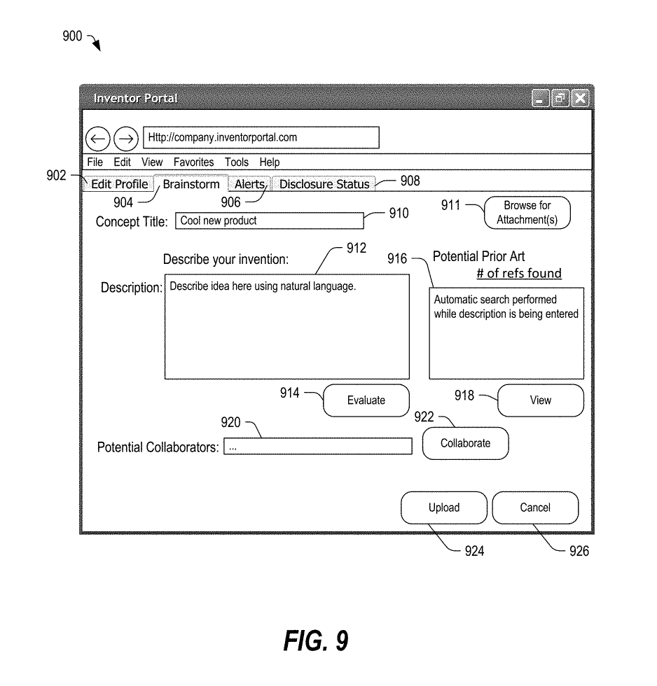

FIG. 9 depicts a GUI 900 that can be presented by the inventor portal to create, review, edit, and submit an invention disclosure document, in accordance with certain embodiments of the present disclosure. The GUI 900 may include an “Edit Profile” tab 902, a “Brainstorm” tab 904, and “Alerts” tab 906, and a “Disclosure Status” tab 908. The GUI 900 may further include a text input 910 for providing a title.

In some embodiments, the GUI 900 can include a “Browse for Attachment(s) tab 911 that can be accessed by a user to select and upload one or more images, one or more documents, or any combination thereof. The GUI 900 may also include an invention description text input 912 and a potential prior art field 918. The GUI 900 may further include an “Evaluate” button 914 that may be selected to initiate a semantic analysis of the text input provided in the text field 912. Further, the GUI 900 may also include a “View” button 918 that may be selected to view one or more of the identified art 916. Further, the GUI 900 may include an indicator of a number of references identified. Other embodiments are also possible.

The GUI 900 may also include a list of potential collaborators 920 and a “Collaborate” button 922, which may be selected to access a popup window from which one or more collaborators may be selected. Other embodiments are also possible.

The GUI 900 may include an “Upload” button 924 accessible to upload the invention disclosure, to insert one or more drawings, and so on. The GUI 900 may also include a “Cancel” button 926 that may be accessed to discard the disclosure.

In some embodiments, a user or operator may interact with the GUI 900 to draft and revise an invention disclosure. In some embodiments, the system may automatically and update the prior art information 916 and the number of references found as the user adds text to the disclosure text field 912. Alternatively, the system may search, evaluate and update the prior art information 916 in response to selection of the “Evaluate” button 914. In some embodiments, selecting the “View” button 918 may cause the GUI 900 to present information regarding one or more references for review by the user.

In some embodiments, the user may interact with the “Alerts” tab 906 to configure one or more alerts, such as alerts to email related prior art when such art is identified. In some embodiments, the user may interact with the “Disclosure Status” tab 908 to review the progress of an invention disclosure through a sequence of disclosure-related tasks.

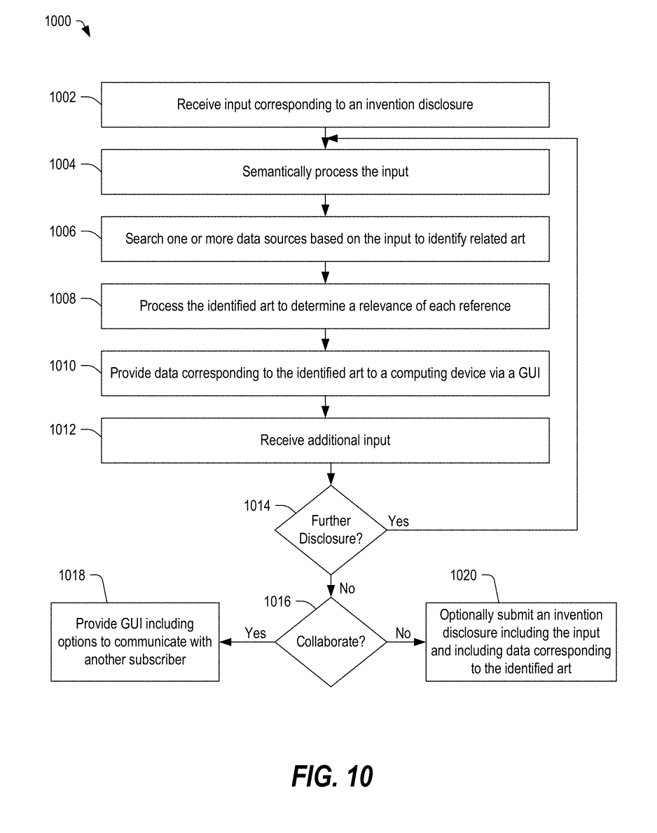

FIG. 10 depicts a flow diagram of a method 1000 of capturing an invention disclosure, in accordance with certain embodiments of the present disclosure. At 1002, the method 1000 may include receiving input corresponding to an invention disclosure. Alternatively, the input may be related to a concept, an idea, a trade secret, or other strategic information. Such information may include text entered in the GUI 900 of FIG. 9 or received via an email. At 1004, the method 1000 may include semantically processing the input. Semantic processing may include determining a semantic signature, statistical information, frequency data, other information, or any combination thereof based on the submitted information.

At 1006, the method 1000 may include searching one or more data sources based on the input to identify related art. The system may generate one or more queries for searching various data sources to identify potentially related prior art references. In some examples, the system may search the data sources based on the semantic signature, statistical information, frequency data, other information, or any combination thereof. At 1008, the method 1000 may include processing the identified art to determine a relevance of each reference.

At 1010, the method 1000 may include providing data corresponding to the identified art to a computing device via a GUI. Alternatively, or in addition, such information may be provided in an email. In some embodiments, the data may include an alert that a similar disclosure was previously submitted. In some embodiments, the data may include an indicator of a number of references found that may be related to the received input. In some embodiments, the data may include excerpts from one or more of the references, other data, or any combination thereof. In certain embodiments, the system may remove information, such as patent claims and the like, from the data provided to the computing device.

At 1012, the method 1000 may include receiving additional input from a user. The additional input may include further information about the submitted concept. At 1014, if the additional input includes further disclosure, the method 1000 returns to 1004 to semantically process the input. Otherwise, at 1014, if the additional input does not include further disclosure, the method 1000 may include determining one or more collaborators. In some embodiments, the system may search private data to identify similar disclosures. In the event that the similarity between the submitted data and the existing disclosure within a threshold semantic distance, the system may communicate an alert to an administrator that the submitted concept may overlap with an existing disclosure. In some examples, the system may also search HR data and other information to identify potential collaborators and may make recommendations of experts and others who may provide potential assistance to a particular idea submission.

At 1016, if the user wants to collaborate, the method 1000 may include providing a GUI including options to communicate with another subscriber, at 1018. The options may include an email options, a text option, or other option for initiating communication. Otherwise, at 1016, if the user does not want to collaborate, the method 1000 may include optionally submitting an invention disclosure including the input and including data corresponding to the identified art.

It should be appreciated that the order of the elements if FIG. 10 may vary, depending on the implementation. In an example, the decision whether to collaborate or communicate with others may be made at a later time, such as after an internal review by an administrator has been conducted. In an example, the administrator may suggest collaborators based on recommendations provided by the system. Other embodiments are also possible.

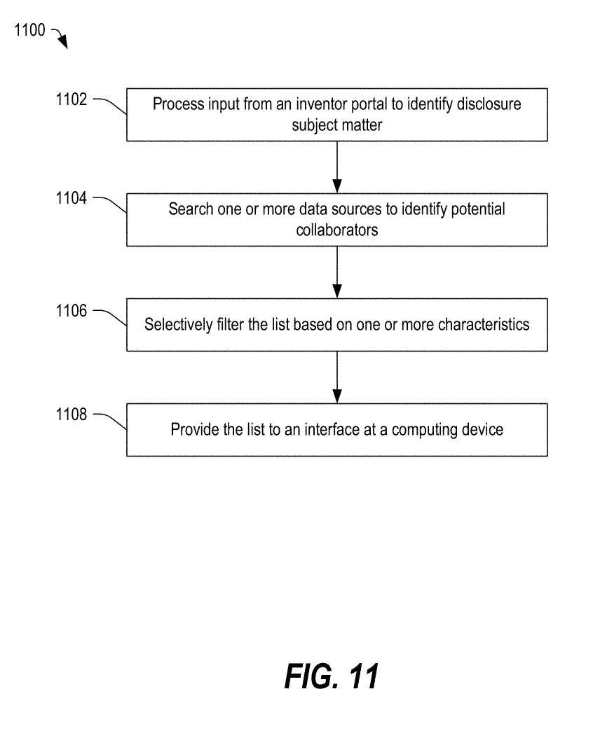

FIG. 11 depicts a flow diagram of a method 1100 of identifying potential collaborators or experts to assist with the invention disclosure, in accordance with certain embodiments of the present disclosure. At 1102, the method 1100 may include processing input from an inventor portal to identify disclosure subject matter. In some embodiments, the processing may include semantically processing the text of the disclosure.

At 1104, the method 1100 may include searching one or more data sources to identify potential collaborators. The data sources may include a disclosures database, an inventors database, the patent office website, other data sources, or any combination thereof. In some instances, the search may identify related disclosures and the potential collaborators may be identified based on a plurality of factors, including proximity, technology area, level of expertise, semantic similarities, prior working relationships, and so on.

At 1106, the method 1100 may include selectively filtering the list based on one or more characteristics. In an example, the list may be filtered based on employer, engineering group, years of experience, other factors, or any combination thereof. In some embodiments, the filtering may be based on rules established by an administrator, such as to keep certain projects isolated. Other rules may also be applied.

At 1108, the method 1100 may include providing the list to an interface at a computing device. In some embodiments, the list may be provided within a GUI provided by the inventor portal system to allow the user to select one or more others to collaborate. In another example, the list may be provided within an email, text, or other communication. Other embodiments are also possible.

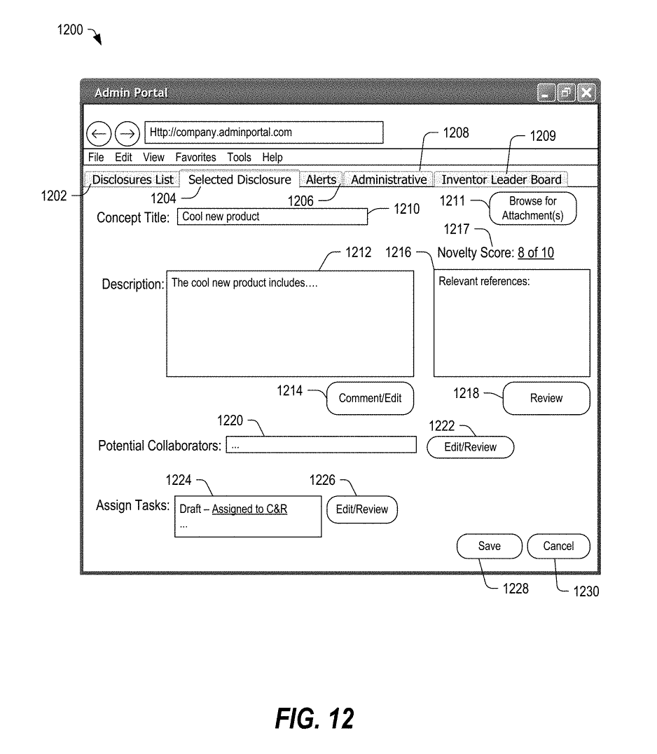

FIG. 12 depicts a GUI 1200 of an administrative portal, in accordance with certain embodiments of the present disclosure. The GUI 1200 includes a “Disclosures List” tab 1202 accessible to view a selectable list of disclosures. The GUI 1200 further includes a “Selected Disclosure” tab 1204 accessible to view and edit a particular disclosure. The GUI 1200 also includes an “Alerts” tab 1206 accessible to configure one or more alerts, including an email alert whenever any element of the selected disclosure changes, including the description, the collaborators, the status, and so on. The GUI 1200 may also include an “Administrative” tab 1208 accessible by a user to access administrative functions. The GUI 1200 may further include an “Inventor Leader Board” tab 1209 accessible to view a list of inventors, which list may be ranked based on various parameters (e.g., number of disclosures, number of accepted disclosures, number of filed patents, number of issued patents, other parameters, or any combination thereof). Other embodiments are also possible.

The GUI 1200 also presents the concept title 1210 and the description 1212. Further, the GUI 1200 may also include a “Browse for Attachments” button 1211 that can be accessed by a user to upload and attach one or more files, such as images, documents, and the like. The GUI 1200 may include a “Comment/Edit” button 1214 accessible to allow the administrator to insert comments and to edit the description. The GUI 1200 may also include relevant references 1216 and an automatically generated novelty score 1217 to assist the administrator in evaluating a particular disclosure. In an example, the novelty score may be determined based on a semantic relevancy score for each reference and a total number of references that are determined to be relevant to the particular disclosure. In one example, documents having a relevancy score greater than 50 of 100 are determined to be relevant. The relevancy scores may be added together and divided by the total number of references to determine an average relevancy (which may be adjusted to a ten point scale) to provide a novelty score. The GUI 1200 may also include a “Review” button 1218 accessible by an administrator to review one or more of the relevant references 1216. Other embodiments are also possible.

The GUI 1200 may also include a list of collaborators 1220 and an “Edit/Review” button accessible to edit or review the list. The GUI 1200 may further include a list of tasks 1224 and an “Edit/Review” button 1226 accessible by an administrator to review and assign tasks. The GUI 1200 may also include a “Save” button 1228 and a “Cancel” button 1230. Other embodiments are also possible.

In some embodiments, the GUI 1200 may be a web-based email system, for example, and the disclosures may be received, assigned, and so on, as emails and email attachments. In another embodiment, the disclosures, assignments, and task processing may be through an email application. Any or all of the GUI, web-based email, and email applications may be used with the system.

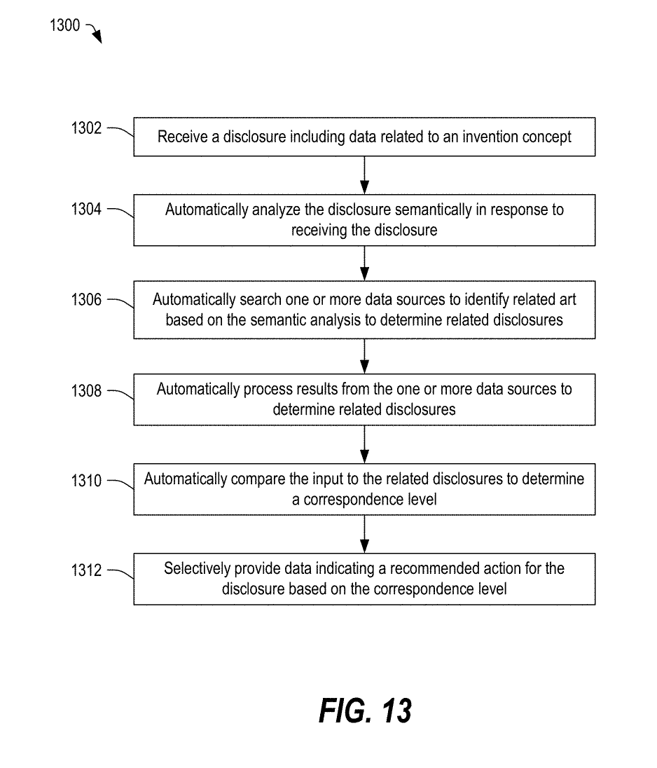

FIG. 13 depicts a flow diagram of a method 1300 of providing an automatic recommendation for a submitted disclosure, in accordance with certain embodiments of the present disclosure. At 1302, the method 1300 may include receiving a disclosure including data related to an invention concept. The data may include submitter information, date and time information, and other information. The disclosure may be received via the inventor portal 102, an email, an email attachment, a scanned document, another source, or any combination thereof.

At 1304, the method 1300 may include automatically analyzing the disclosure semantically in response to receiving the disclosure. The analysis may include producing semantic signatures and associated content analytics for the submitted information. At 1306, the method 1300 may include automatically searching one or more data sources to identify related art based on the semantic analysis to determine related disclosures. The data sources may include private data. At 1308, the method 1300 may further include automatically processing results from the one or more data sources to determine related disclosures. The results may be extracted, transformed and loaded into temporary tables, semantically processed, or otherwise analyzed automatically. In some instances, based on the level of similarity, the submitted information may be tagged as similar to a pre-existing disclosure or project.

At 1310, the method 1300 may include automatically comparing the received disclosure to the related disclosures to determine a correspondence level, such as a relevancy score. At 1312, the method 1300 may include selectively providing data indicating at a recommended action for the disclosure based on the correspondence level. In some embodiments, the data may include a “novelty” score, an indicator of a number of references, excerpts from one or more references, other data, or any combination thereof. In an embodiment, the data may include a recommendation such as “Pursue”, “Do Not Pursue”; “Need More Information”; other data, or any combination thereof. Other embodiments are also possible.

In some embodiments, the recommendation may be provided as a letter grade, a color code, a thumbs up or down, another indicator, or any combination thereof. Further, the recommendation may include recommendations for collaboration or consolidation. Other embodiments are also possible.

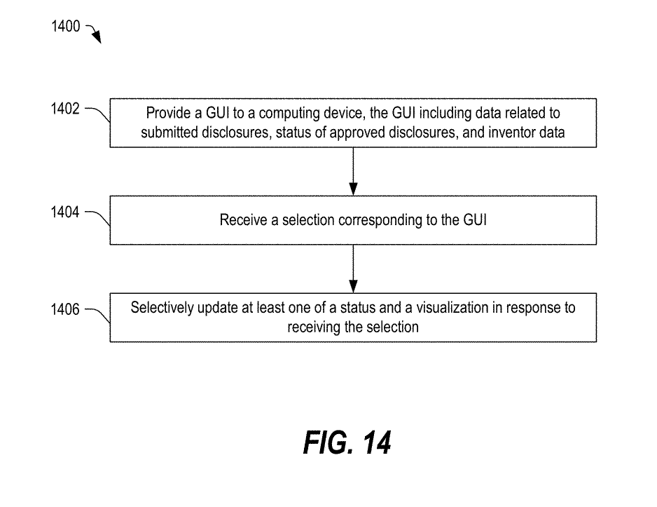

FIG. 14 depicts a flow diagram of a method 1400 of selectively updating an administrative portal, in accordance with certain embodiments of the present disclosure. At 1402, the method 1400 may include providing a GUI to a computing device, where the GUI may include data related to submitted disclosures, status of approved disclosures, and inventor data. In some embodiments, the GUI may be an email interface. The GUI may also include an inventor leader board ranking inventors based on one or more parameters. The inventor leader board may also be grouped by internal organization, division, location, etc. In an example, the leader board may be categorized, grouped, sorted, or any combination thereof according to a selected one of the parameters. In an example, the GUI may be an embodiment of the GUI 1200 in FIG. 12.

At 1404, the method 1400 may include receiving a selection corresponding to the GUI. In an example, the selection may correspond to one or more selectable elements within the GUI, such as tabs, buttons, clickable links, and the like. At 1406, the method 1400 may include selectively updating at least one of a status and a visualization in response to receiving the selection. In an example, the administrator may interact with the GUI to assign a task, to return the disclosure to an inventor for additional information, and so on. The interactions may cause the GUI to be updated.

In some embodiments, an email type of system may be used. In certain examples, a zero-inbox type of policy may be applied to facilitate prompt review and handling of submitted ideas. Other embodiments are also possible.

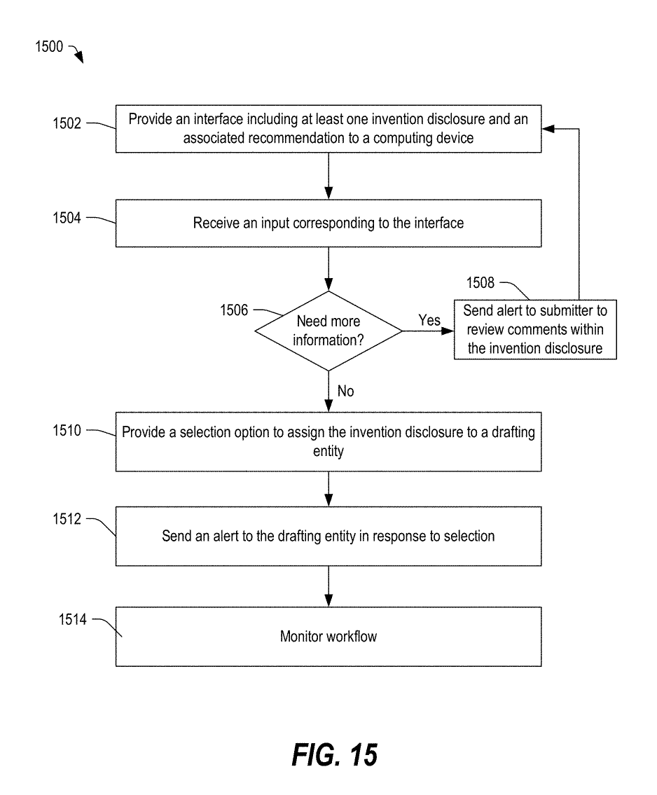

FIG. 15 depicts a flow diagram of a method 1500 of managing an IP asset, in accordance with certain embodiments of the present disclosure. At 1502, the method 1500 may include providing an interface including at least one invention disclosure and an associated recommendation to a computing device. At 1504, the method 1500 may include receiving an input corresponding to the interface. The input may include a selection of one or more selectable elements.

At 1506, if the input indicates that more information is needed, the method 1500 may include sending an alert to a submitter to review comments within the invention disclosure, at 1508. The method 1500 may then return to 1502. Otherwise, if more information is not needed, the method 1500 may include providing a selection option to assign the invention disclosure to a drafting entity, at 1510. The selection option may include a pulldown menu or other selectable element.

At 1512, the method 1500 may include sending an alert to the drafting entity in response to the selection. The alert may include an email with a link to the disclosure or with a disclosure document attached. At 1514, the method 1500 may include monitoring a workflow associated with the disclosure. In an embodiment, the system may monitor progress of the disclosure, interview, drafting, revision, and filing tasks to ensure that the disclosure is processed in a timely and efficient manner. Other embodiments are also possible.

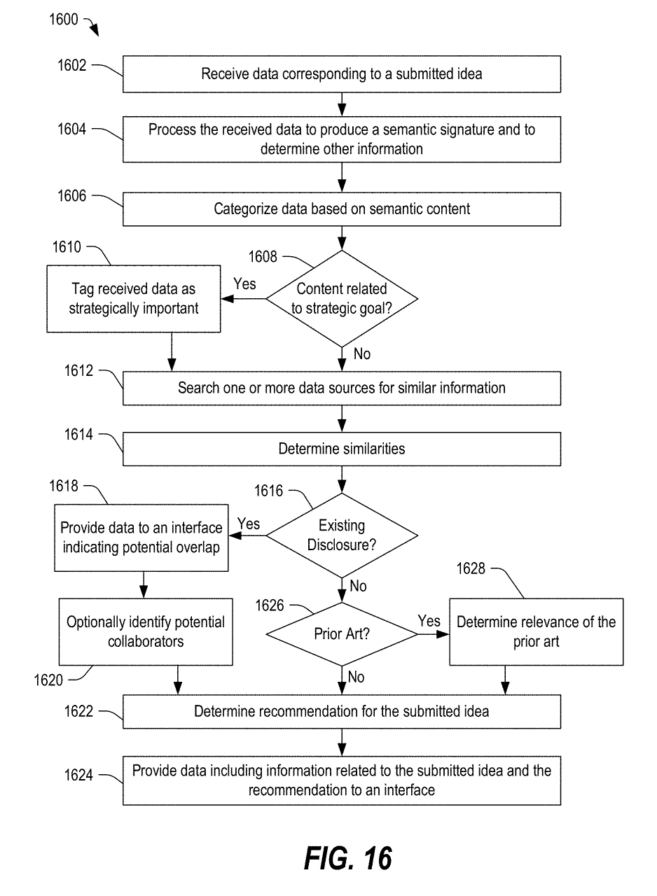

FIG. 16 illustrates a flow diagram of a method 1600 of processing a submitted idea, in accordance with certain embodiments of the present disclosure. At 1602, the method 1600 may include receiving data corresponding to a submitted idea. The data may be received from an email (text or attachment), a web interface (text, input selections, attachments, or any combination thereof), another source, or any combination thereof.

At 1604, the method 1600 may include processing the received data to produce a semantic signature and to determine other information. The semantic signature may be determined by linking various terms, contextual cues, other data, or any combination thereof. Further, the other information may include term frequency, term proximity, statistical data derived from the document, or any combination thereof.

At 1606, the method 1600 may include categorizing data based on the semantic content. In an example, a particular organization may categorize submitted information according to a plurality of attributes, including (for example) technology area, division, project, product, submitter's location, another attribute, or any combination thereof.

At 1608, the method 1600 may include determining if the submitted content is related to a strategic goal. In some examples, semantic data derived from the submitted content, such as keywords, a semantic signature, and the like, may be compared to keywords, which may be selected or configured by an administrator to flag particular ideas or categories of ideas as being important strategically, such as being directed to a subject area that has been determined to be important strategically for the organization. In an example, the system may generate an alert (e.g., an email) to an idea submission coordinator or other administrator when an idea is submitted that includes content matching one or more of the strategic trigger words.

At 1608, if the content is related to the strategic goal, the method 1600 may include tagging the received data as strategically important, at 1610. Such tagging may include adding one or more data items to the received data before storing the data in a database. Further, the tagging may trigger the system to send an email or other alert.

At 1612, the method 1600 may include searching one or more data sources for similar information. The method 1600 may perform such searching after tagging the received data (at 1610) and when the content is not related to the strategic goal (at 1608). The search may include both private data and publicly available data sources. The private data, for example, may include previously submitted disclosures.

At 1614, the method 1600 may include determining similarities between the retrieved documents and the submitted content. In an example, the extent of similarity may be determined by analyzing keyword frequency, semantic signatures, submitter data, division data, project data, other information, or any combination thereof.

At 1616, if the identified similar document is an existing (previously submitted) disclosure, the method 1600 may include providing data to an interface including potential overlap, at 1618. At 1620, the method 1600 may include optionally identifying potential collaborators. Further, the method 1600 may include determining a recommendation for the submitted idea, at 1622, and providing data including information related to the submitted idea and the recommendation to an interface, at 1624. In some embodiments, a recommendation may be determined based on the lack of similarity between identified related references and the submitted information, the strategic importance of the submitted information, other considerations, or any combination thereof. In some examples, the submitted idea and the recommendation may be sent via an email, a text message, a web form, an attachment, or any combination thereof.

Returning to 1616, if the similar document is not related to an existing disclosure, the method 1600 may include determining if the existing disclosure is prior art, at 1626. If the existing disclosure was previously submitted and has been made public in some way, the method 1600 may include determining relevance of the prior art, at 1628. The method 1600 may then proceed to determining a recommendation for the submitted idea, at 1622, and providing data including information related to the submitted idea and the recommendation to an interface, at 1624.

If at 1626, the prior disclosure was maintained in secret, the method 1600 may proceed to determining a recommendation for the submitted idea, at 1622, and providing data including information related to the submitted idea and the recommendation to an interface, at 1624.

Further, in conjunction with the systems, methods and devices described above with respect to FIGS. 1-16, an IP asset management system is described that may be configured to receive idea submissions and to evaluate and coordinate processing of such submissions. In some examples, the IP asset management system may enable an administrator to review disclosures, review related information, recommend collaborators, identify potential export control issues, identify potential conflicts or overlaps, or any combination thereof. In some examples, the IP asset management system may automatically make recommendations regarding various disclosures to assist the administrator in making his or her decisions. Other embodiments are also possible.

Further, the systems described herein may be used to gamify idea submission. By creating a leaderboard through which idea submission may be recognized, competition may be created within an organization, between inventors, within and between divisions, and so on. By gamifying the submission process, idea submissions may be encouraged by establishing a culture within which such submissions are valued.

The processes, machines, and manufactures (and improvements thereof) described herein are particularly useful improvements for computers including access to multiple data sources. Further, the embodiments and examples herein provide improvements in the technology of resume generation. In addition, embodiments and examples herein provide improvements to the functioning of a computer by providing enhanced results, automated and facilitated resume generation, thereby creating a specific purpose computer by adding such technology. Thus, the improvements herein provide for technical advantages, such as providing a system in which a user's interaction with a computer system allows for rapid generation of an invention disclosure based on iterative interactions between the input GUI and corresponding search results presented within the GUI. Further, the system provides automated resume generation based on publication data, social media data, and so on. Additionally, the system provides automated recommendations for collaborating with respect to an invention disclosure. Moreover, the system allows administrators to oversee the disclosure process, including reviewing, commenting, requesting further information, assigning tasks, and monitoring workflows. While technical fields, descriptions, improvements, and advantages are discussed herein, these are not exhaustive and the embodiments and examples provided herein can apply to other technical fields, can provide further technical advantages, can provide for improvements to other technologies, and can provide other benefits to technology. Further, each of the embodiments and examples may include any one or more improvements, benefits and advantages presented herein.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, in the flow diagrams presented herein, in certain embodiments, blocks may be removed or combined without departing from the scope of the disclosure. Further, structural and functional elements within the diagram may be combined, in certain embodiments, without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A system comprising:
an interface configured to communicate with a computing device through a network;
a processor coupled to the interface; and
a memory accessible to the processor, the memory configured to store instructions that, when executed, cause the processor to:
receive an invention disclosure;
semantically process the invention disclosure;
search one or more data sources based on the invention disclosure to identify related documents; and
provide a graphical interface including the invention disclosure and data corresponding to the related documents to a computing device through the network.

2. The system of claim 1, wherein the memory further includes instructions that, when executed, cause the processor to:
retrieve data corresponding to a name from one or more data sources; and
automatically populate a selected resume template to include the name and at least some of the data retrieved from the one or more data sources.

3. The system of claim 2, wherein the one or more data sources include at least one social media website.

4. The system of claim 2, wherein the memory further includes instructions that, when executed, cause the processor to generate a graphical user interface including:
a first portion including data to be included in the resume; and
a second portion including at least some of the data retrieved from the one or more data sources.

5. The system of claim 1, wherein the memory further includes instructions that, when executed, cause the processor to:
provide the graphical interface including one or more selectable disclosures;
receive a selection of a selected disclosure of the one or more selectable disclosures; and
provide data including the selected disclosure within the graphical interface, the data including at least one of a novelty score, a recommendation whether to pursue, and a list of related art.

6. The system of claim 5, wherein the memory further includes instructions that, when executed, cause the processor to:
receive an input corresponding to the selected disclosure, the input including at least one of an update to the disclosure and the assignment of a task associated with the disclosure; and
selectively sending an alert to one of a user associated with the invention disclosure and an entity to which the task is assigned.

7. The system of claim 1, wherein the one or more data sources includes a disclosures database that includes private data.

8. A system comprising:
an interface configured to communicate with a computing device through a network;
a processor coupled to the interface; and
a memory accessible to the processor, the memory configured to store instructions that, when executed, cause the processor to:
receive an invention disclosure from the computing device associated with a user;
automatically update a resume associated with the user using a resume builder in response to receiving the invention disclosure;
provide an asset management interface accessible by an administrator to review, edit, and provide comments to a selected one of the a plurality of invention disclosures including the received invention disclosure, the asset management interface accessible by the administrator to assign the selected one of the plurality of invention disclosures to one of a law firm, an individual, and a department and to monitor progress of completion of tasks associated with the invention disclosure.

9. The system of claim 8, wherein the memory further includes instructions that, when executed, cause the processor to calculate statistics associated with a plurality of inventors and to generate at least one visualization corresponding to the statistics.

10. The system of claim 9, wherein the at least one visualization comprises a leaderboard provided to an interface produced by an inventor portal.

11. The system of claim 8, wherein the memory further includes instructions that, when executed, cause the processor to automatically provide one or more prompts within the GUI, the one or more prompts configured to extract information corresponding to the invention.

12. The system of claim 8, wherein the memory further includes instructions that, when executed, cause the processor to analyze the invention disclosure semantically and to search one or more data sources based on semantic data extracted from the invention disclosure to identify one or more related references.

13. The system of claim 12, wherein the memory further includes instructions that, when executed, cause the processor to automatically calculate a novelty score for the invention disclosure based on an average relevancy score of the one or more references.

14. The system of claim 8, wherein the memory further includes instruction that, when executed, cause the processor to:
receive a selection related to the selected one of the plurality of invention disclosures; and
display details related to the selected one and including a progress indicator indicating a status of completion a plurality of tasks to be performed relative to the selected one.

15. A system comprising:
an interface configured to communicate with a computing device through a network;
a processor coupled to the interface; and
a memory accessible to the processor and configured to store instructions that, when executed, cause the processor to:
provide a graphical user interface (GUI) to the computing device, the GUI including one or more user-selectable elements accessible by a user to provide information related to an invention;
receive an invention disclosure in response to providing the GUI;
semantically process the invention disclosure to identify one or more related documents; and
selectively update the GUI to include data corresponding to the one or more related documents.

16. The system of claim 15, wherein the memory further includes instructions that, when executed, cause the processor to automatically provide one or more prompts within the GUI, the one or more prompts configured to extract information corresponding to the invention.

17. The system of claim 15, wherein the memory further includes instructions that, when executed, cause the processor to automatically determine a novelty score corresponding to the invention disclosure based on the one or more related documents.

18. The system of claim 15, wherein the memory further includes instructions that, when executed, cause the processor to automatically update a resume associated with the user in response to receiving the invention disclosure.

19. The system of claim 15, wherein the memory further includes instructions that, when executed, cause the processor to automatically identify one or more other users who are potential collaborators based on prior experiences.

20. The system of claim 15, wherein the memory further includes instructions that, when executed, cause the processor to provide a second GUI through which an administrator may review the invention disclosure.
